(19) United States
(12) Patent Application Publication
(10) Pub. No.: US 2016/0378206 A1
(43) Pub. Date: Dec. 29, 2016

(54) CIRCULAR, HAND-HELD STRESS MOUSE

(71) Applicant: Intel Corporation, Santa Clara, CA (US)

(72) Inventors: Tamela J. Bartolo, Pollock Pines, CA (US); James J. Kim, Sherwood, OR (US); Yasaman A. Ghazizadeh, Los Gatos, CA (US); Kenneth Paul Follosco, Santa Clara, CA (US); Phillip N. Smesrud, Beaverton, OR (US); Cathy N. Vittum Wick, Hillsboro, OR (US); Sadhana Allen, Emerald Hills, CA (US)

(73) Assignee: INTEL CORPORATION, Santa Clara, CA (US)

(21) Appl. No.: 14/752,742

(22) Filed: Jun. 26, 2015

(51) Int. Cl. G06F 3/0354; A63B 43/00; A63B 21/00; G06F 1/16

(52) U.S. Cl. CPC G06F 3/03543; G06F 1/1698; G06F 1/1694; A63B 43/00; A63B 21/00189

(57) ABSTRACT

The present embodiments provide a pointing device and method for using the pointing device to manipulate data on a display screen of a computing device. Components of the pointing device may include one or more sensors to detect at least one hand movement acting upon the mouse and one or more controllers to translate the at least one hand movement into a mouse action. Components of the pointing device may also include a transmitter to transmit the mouse action to a computing device, and a mouse housing comprising a soft, pliable material, wherein the one or more, the one or more controllers, and the transmitter are embedded within the soft, pliable material.

### TECHNICAL FIELD

The present disclosure relates generally to a multi-functioning pointing device. More specifically, the present disclosure describes a circular, hand-held stress mouse that may be used as a computing input device or as a stress ball.

### BACKGROUND

A computing mouse (“mouse”) is an input device used to control a pointer in order to manipulate visible data on a display screen. The pointer is a small symbol that acts as an interface between the mouse and the display screen and is displayed on the display screen to simulate the movements and actions of the mouse. A user typically operates a mouse by rolling it along a hard, flat surface. Once the mouse detects such movements, it sends a signal to the computing device to display the movement of the pointer on the display screen. However, repeated use of the mouse may be related to computing-related health issues associated with the body including the hands, wrists, arms, and neck, among others.

### BRIEF DESCRIPTION OF THE DRAWINGS

Certain exemplary examples are described in the following detailed description and in reference to the drawings, in which:

FIG. 1 is a block diagram of an example of a system for a circular, hand-held stress mouse.

FIG. 2 is an example of a circular, hand-held stress mouse.

FIGS. 3A and 3B are examples of circular hand-held stress mice configured with internal frame structures.

FIGS. 4A and 4B are examples of various shaped hand-held stress mice.

FIGS. 5A-5C are examples of hand movements corresponding with a point mouse action.

FIG. 6 is an example of a hand movement corresponding with a select mouse action.

FIGS. 7A-7C are examples of hand movements corresponding with a menu mouse action.

FIG. 8 is a process flow diagram for manufacturing a circular, hand-held stress mouse.

FIG. 9 is a block diagram showing a tangible, non-transitory computer-readable media that stores code for the circular, hand-held stress mouse.

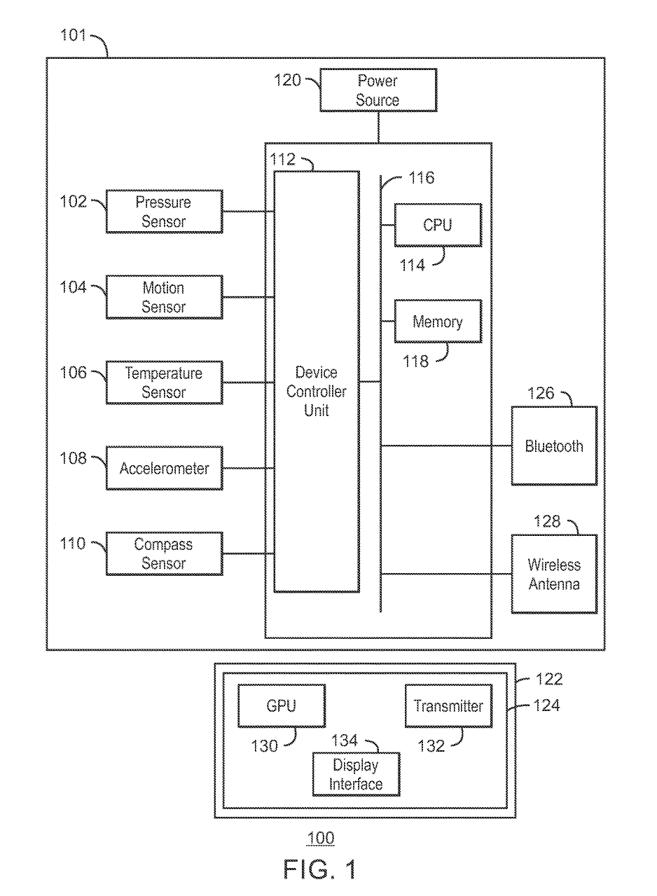

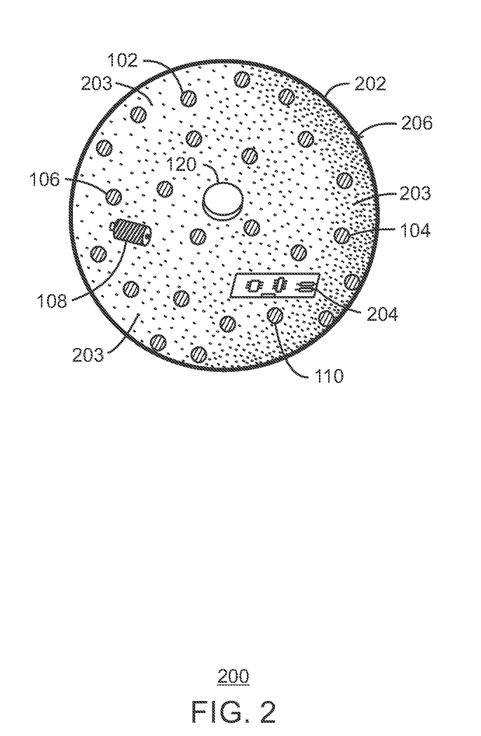

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

One of the main goals of a computing mouse is to translate the motion of a human user's hand into command signals. Specifically, the mouse transmits the command signals to a computing device to control the movement of a pointer on a display screen. The mouse may manipulate data, including pointing, selecting, searching, dragging, and highlighting, among other functions, on the display screen. For example, the mouse may enable a user to switch between computing applications, select options and buttons displayed on the display screen, move between and select links on a website, and many other tasks that may be difficult to carry out using a keyboard or other types of pointing devices.

However, use of the mouse may induce ergonomic related injuries due to excessive and repetitive hand movements. As an example, a Repetitive Stress Injury (“RSI”) is a common type of ergonomic related injury associated with use of a conventional computing mouse. RSI often occurs due to the repeated movement, lack of movement, or both, of the muscles and joints in the hand, wrist, arm, neck, back and shoulder. Embodiments described herein enable a circular, hand-held stress mouse that can be used in numerous locations, positions, and subjected to frequent changes in hand movements. Additionally, the mouse may be disabled and used as a stress ball to eliminate or reduce body stress and tension.

FIG. 1 is a block diagram of an example system 100 for a circular, hand-held stress mouse, herein referred to as “mouse” 101. The system 100 may enable a human user, herein referred to as “user,” to use the mouse 101 in numerous locations and positions with various hand movements that may change frequently. The user may physically hold the mouse 101 in a hand to manipulate it with the various hand movements. The use of the user's hand may include the palm of the hand and the fingers. The user may also manipulate the mouse 101 with a hand while it is simultaneously in contact with a surface. The hand movements acting upon the mouse 101 may be imitated on a display screen using a pointer or other visual changes.

The system 100 may include various sensors to detect the hand movements. In particular, the system 100 may include pressure sensors 102, motion sensors 104, temperature sensors 106, accelerometers 108, and compass sensors 110, among other electrical sensors. Each sensor may aid in detecting hand movements that act upon the mouse 101. The hand movements that may act upon the mouse 101 may include tapping, rolling, bouncing, swiping, elevating, and squeezing, among others. In some examples, the hand movements may be combined with algorithms, such as behavioral algorithms, to increase detection and conversion accuracy of the movements. Moreover, the algorithms may embody the rules of logic for controlling actions of the mouse 101. In this manner, the mouse may be programmed to meet the needs of the user and across different form factors.

The pressure sensors 102 and the motion sensors 104 may monitor the mouse 101 to detect the hand movements, including finger movements, and hand gestures. The acceleration sensors, such as an accelerometer 108, may measure and identify the orientation of the mouse 101, such as an upward orientation or a downward orientation, and the acceleration of the hand movements. In other configurations, the mouse 101 may include a compass sensor 110 to increase the accuracy of the accelerometer 108 by detecting additional directional movements.

In order to distinguish between a touch by a human and an inanimate object, the mouse 101 may use a temperature sensor 106 to measure the temperature of the object that touches the mouse 101. The temperature sensor 106 may be programmed to detect a human touch based on a specified temperature range, for example, a range of normal body temperatures of a human. Additionally, when the user is subjected to cold temperatures, the temperature sensor 106 may be calibrated to account for variations associated with normal body temperatures and for ambient temperature conditions. The various sensors may be configured in sequence to detect a human touch. For example, the sequence of the sensors may include detection by a motion sensor, detection by a temperature sensor, and detection by a pressure sensor, among other combinations. The sequence of sensors may further distinguish between a human touch and an inanimate object.

Each sensor may transmit data related to the hand movements to a device controller unit 112 electrically connected to each sensor. The device controller unit 112 may translate the hand movement into a mouse action. The mouse action may include a point action, a move action, a select action, an access-menu action, or a zoom action, among others. Each type of action may correspond with a particular hand movement. Further, each action may describe the visual changes associated with the pointer, as displayed on the display screen. In examples, the manufacturer or end-user may implement additional hand movements and mouse actions, at their discretion.

The device controller unit 112 may transmit the mouse actions to a central processing unit (CPU) 114 that may be adapted to execute the mouse actions. The CPU 114 can be a single core processor, a multi-core processor, a computing cluster, or any number of other configurations. The device controller unit 112 and the CPU 114 may be electrically coupled via a system bus 116 to control the transmission of the mouse actions from the device controller unit 112 to the CPU 114. The CPU 114 may execute the mouse actions to determine the type of mouse action. For instance, the user may initiate a hand movement, such as tapping on the mouse, which is sensed by the sensors. The device controller unit 112 may receive the data from the sensors and may translate it to a particular type of mouse action, for example a point mouse action. In this way, the point mouse action may correspond with the hand movement of tapping on the mouse 101. Accordingly, the hand movement of tapping on the mouse 101 with a finger may be used to carry out the mouse action of pointing to an item on a display screen.

The system bus 116 may couple the CPU 114 to a memory device 118, which may also store mouse actions that are executable by the CPU 114. The memory device 118 can include random access memory (RAM), read only memory (ROM), flash memory, or any other suitable memory systems. Further, the mouse 101 may include a power source 120 to power the mouse 101. For example, the power source 120 may include a rechargeable source, such as a rechargeable battery located within the mouse 101.

The mouse may communicate with a computing device 122 with a display screen 124 using various technologies. For instance, the system 100 may include Bluetooth technology where the system 100 may include a Bluetooth antenna 126 to pair the mouse 101 with the computing device 122. The system 100 may also include WiFi capabilities and thus, may include a wireless antenna 128 built into the mouse 101. The Bluetooth antenna 126, the wireless antenna 128, or any other type of wireless transmission technology may transmit the mouse actions to the computing device 122. The computing device 122 may include a laptop computer, a desktop computer, and a tablet computer, among others. The display screen 124 may be integrated into the computing device or may be an external display, projector, television, and the like.

The computing device 122 with the display screen 124 may include a graphics processing unit (GPU) 130. The GPU 130 may be configured to perform any number of graphics operations related to the mouse 101 by analyzing the mouse actions. Following the previous example, the CPU 114 may transmit the point mouse action to the computing device 122, in particular, to the GPU 130. The GPU 130 may use the data related to the point mouse action to render a graphic image based on that data.

A transmitter 132, located in the computing device 122, may encode and transmit the graphic image rendered by the GPU 130 to a display interface 134. The display interface 134 may enable signals related to the graphic image to be rendered to the display screen 122. In particular, the display interface 134 may use the graphic image rendered by the GPU 130 to move a pointer on the display screen 124. The movement of the pointer on the display screen 124 may be based on the coordinates of a specific type of mouse action. Using the previous example, if the graphic image is based on a point mouse action, the pointer may be displayed on the display screen 124 as carrying out actions, such as pointing to and selecting an item on the screen 124.

FIG. 2 is an example of a circular, hand-held stress mouse 200. Like numbers are as described with respect to FIG. 1. The mouse 200 may include a mouse housing 202 formed into a circular shape. The circular shape enables the mouse 200 to directly roll on a surface, for example, in the palm of a user's hand. The mouse housing 202 may primarily be made of a pliable material 203. In other examples, as will be described, the pliable material 203 may act as a covering to cover a mouse housing configured as an internal frame structure. The pliable material 203 may include any type of soft, flexible material that can be shaped into a desired form, yet, substantially strong and durable to withstand repeated stresses during normal usage. In some examples, the pliable material 203 may include a gel material, a foam material, a plastic material, a fabric material, a rubber material, and so forth.

The mouse 200 may contain numerous electronic components, such as the sensors 102, 104, 106, 108, 110 and the power source 120, among others. The various sensors may be placed within the pliable material 203 to adequately detect human user contact, such as hand movements and finger movements. In some embodiments, the various sensors may be flexible, thin, and customizable so as to substantially embedded within the pliable material 203.

The CPU 114 and the memory 118, among other electronic components of the mouse 200, may be mounted on a circuit board 204. In some embodiments, the circuit board 204 may be flexible, thin, and customizable so as to substantially embedded within the pliable material 203.

The electronic components may be located directly beneath an external surface 206 of the mouse 200 so as not to be detectable either visibly or physically. For example, the electronic components, as shown in FIG. 2, may be embedded within the pliable material 203 so as to be surrounded by the material. In this way, a substantial portion of the mouse 200 is made of the pliable material 203.

The pliable material 203, or any other type of soft, pliable material, may be used to cover the external surface 206 of the mouse 200 to provide an external covering. In other implementations, the electronic components may be mounted within an internal frame structure that may be embedded within the pliable material 203, as will be further described.

The mouse 200 may be disabled and thus, rendered inoperable as a computing mouse. In the present examples, a pressure detected upon the mouse 200 beyond a predetermined pressure may signal that the user desires to disable the computing mouse functions. In other examples, inactivity of the mouse 200 for a predetermined time may power down and disable the mouse 200 from further use as a computing mouse.

Once the mouse 200 is disabled, it may be used as a stress ball. The stress ball may be squeezed by a hand or manipulated by fingers to either relieve stress and muscle tension or to exercise the muscles of the hand, among other benefits. In some embodiments, the use of the mouse 200 can be restricted within a predetermined distance away from the computing device 122. An alert may trigger when the mouse 200 moves beyond the predetermined distance.

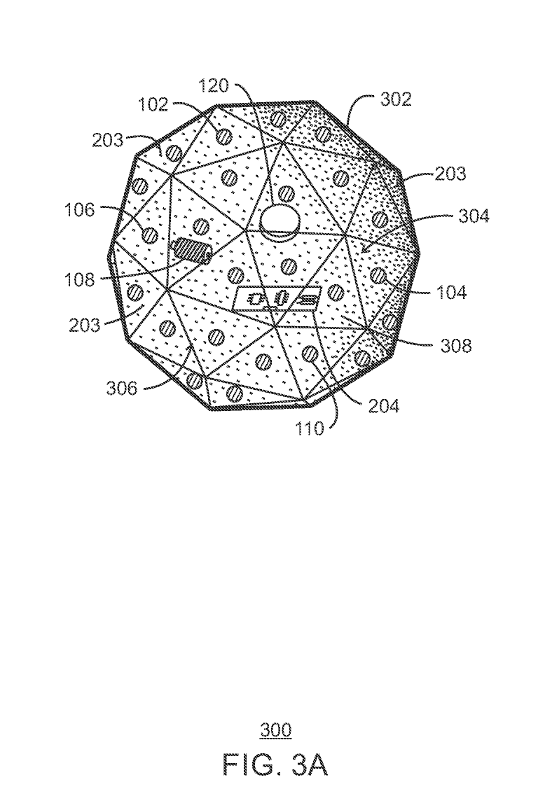

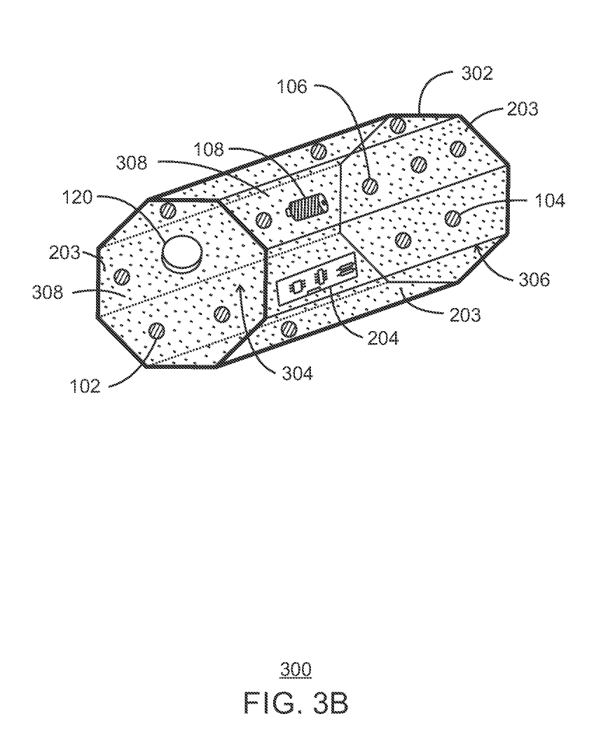

FIGS. 3A and 3B are examples of a circular hand-held stress mouse 300 with an internal frame structure 302. Like numbers are as described with respect to FIGS. 1 and 2. As shown in FIG. 3A, the internal frame structure 302 may be made of various triangular-shaped prism segments configured into a spherical shape. Likewise, as shown in FIG. 3B, the internal frame structure 302 may be made of various longitudinal prism segments configured into a cylinder shape. The structure 302 may be a single, unitary member that includes an inner surface 304 and an outer surface 306 where openings 308 extend from the outer surface 306 to the inner surface 304.

The internal frame structure 302 may be made of a plastic material or any other type of material that may be flexible and bendable, yet, substantially durable in nature to withstand repeated stresses enacted by a user. The electronic components, including the sensors 102, 104, 106, 108, 110, the power source 120, and the circuit board 204, may be housed within the inner surface 304 of the internal frame structure 302. As previously discussed, the sensors and the circuit board 204 may be flexible.

The internal frame structure 302, along with the components, may be embedded within the pliable material 203 so as to substantially cover the structure 302 and to surround the components. The pliable material 203 may cover the outer surface 306 of the structure 302 to provide an external covering. The pliable material 203 may be substantially strong and durable to withstand repeated stresses during normal usage.

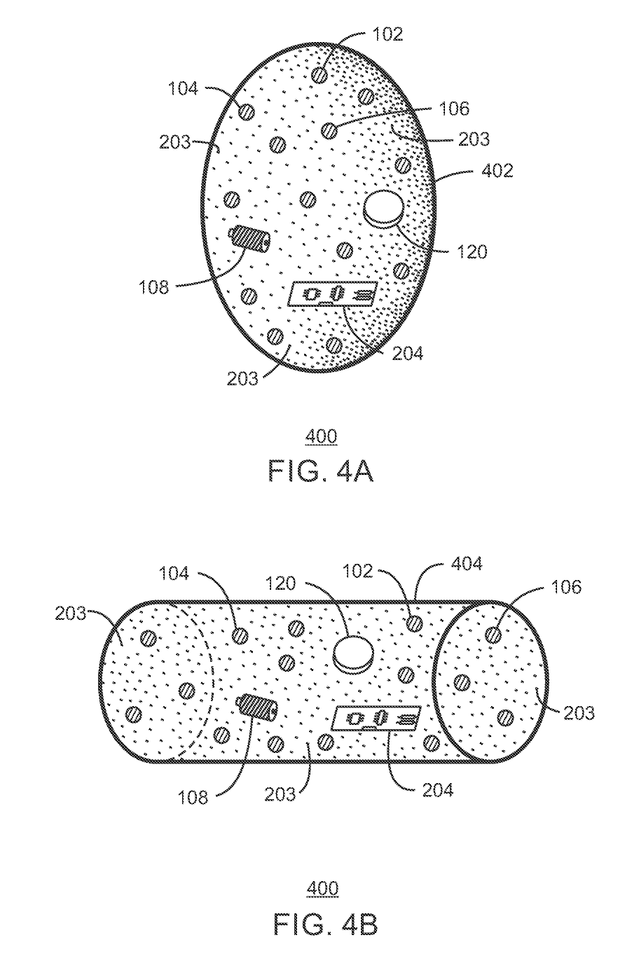

FIGS. 4A and 4B are examples of various shaped hand-held stress mice. As shown in FIG. 4A, the mouse housing 402 may include an oval shape or elliptical shape. In FIG. 4B, the mouse housing 404 may include a cylinder shape. In FIGS. 4A and 4B, the electronic components, i.e., sensors 102, 104, 106, 108, 110, the power source 120, and the circuit board 204, among other components may be embedded in the pliable material 203 so as to be surrounded by the material. As shown in FIGS. 4A and 4B, the pliable material 203 may cover an outer surface of the mouse 402, 404 to provide an external covering.

The mouse of the present disclosure may be formed into any shape that can roll on a surface. The surface may include either a hard surface or a soft surface, such as a desk or a human hand of a user. The mouse of the present disclosure, regardless of the shape, may include the internal frame structure 302, based on design specifications.

TABLE I
MOUSE FUNCTIONALITIES

| Mouse | | |
|---|---|---|
| Action | User Hand Movement | Function of Mouse Action |
| Point and | Tap on mouse with finger to select | To point and select an item or choose a |
| Select | Bounce the mouse on any surface to | command on the display screen |
| | select | |
| Move | Tap on mouse with finger to select, then | To move an item on the display screen |
| | roll the mouse on any surface | |
| | Bounce the mouse on any surface, then | |
| | roll the mouse | |
| Select | Tap twice on the mouse in rapid | Shortcut technique to access an item or to |
| | succession | open/close a window without using a menu |
| | Tap the mouse on any surface twice | |
| Access-Menu | Tap the mouse with two fingers | To access a drop down menu to choose a |
| | simultaneously while the mouse rests on | command |
| | any surface | |
| | Tap the mouse with two fingers | |
| | simultaneously while holding the mouse | |
| | in hand | |
| Zoom Out | Single-squeeze the mouse | To make items on the display appear |
| | Press the mouse on any surface | smaller |
| | Swipe fingers together over the surface | |
| | of the mouse | |
| Zoom In | Double-squeeze the mouse | To make items on the display appear |
| | Swipe fingers apart over the surface of | larger |
| | the mouse | |

As shown, Table I provides a list of the various mouse actions, a corresponding hand movement for each action, and a description of the functions that each mouse action may provide. Each mouse action is further described in detail.

Point and Select Action

By carrying out a point and select hand movement upon the mouse, a user may point to an item displayed on a display screen by moving a pointer to a certain location on the screen and then selecting the item. The mouse action of pointing and selecting may include the user tapping on the stress mouse with a finger or bouncing the mouse on any surface to select an item or choose a command on the display screen. In this way, the point and selection action may alert the computing device that the user is making a selection of an item on the display screen. The point and selection action may highlight an item in a window, activate buttons in a dialog box, or produce a menu on the display screen, among others actions.

Move Action

A user may move an item displayed on a display screen with the mouse by dragging the item across the screen to a desired location. The user of the mouse may use several hand movements to carry out the move action. For example, the user may tap on the mouse with a finger to select, then roll the mouse on any surface. Likewise, the user could bounce the mouse on any surface, then roll the mouse. The surface can include a hard surface, such as a top of a desk or an arm of a chair, or a soft surface, such as the user's hand. By using performing the move action on the mouse, the user can, for example, move files and folders to different windows and move icons around on the screen.

Select Action

Using a hand movement corresponding with the selection action, the user may access an item on the display screen. Moreover, the same hand movement may open or close a window on the display without accessing a menu. The mouse action of selecting may include the user tapping twice in rapid succession on the mouse with a finger. Additionally, the user may tap the mouse twice, on any surface, in rapid succession. In some examples, the user may use the select action to open a new window in a word processing application without initially accessing and opening a menu and thereafter, selecting the ‘open new window” option.

Access Menu Action

A user may access a drop down menu to choose a command using a hand movement corresponding with the access menu action. The mouse action of selecting may include the user tapping twice with two fingers on the mouse while simultaneously resting the mouse on a surface. Additionally, the user may tap twice with two fingers on the mouse while simultaneously holding the mouse in a hand. A user may use the access action to activate a menu displayed on the screen and selecting a command from the menu. For example, if a user desires to change the font size of text, the user can carry out the access action to access and open the font menu and thereafter, select the desired font size.

Zoom Action

By carrying out a hand movement upon the stress mouse, a user may zoom in and out of a display screen. Specifically, the user may provide a single-squeeze, press the stress mouse on any surface, or swipe the fingers together over the surface of the mouse. Such hand movements may zoom-out of the display screen to reduce the viewing size of the display. The mouse action of zoom-in may include a double-squeeze or swipe of the surface mouse with the fingers apart. For example, the user may perform the zoom-in hand movement to see a more detailed, enlarged view of the content on the display screen.

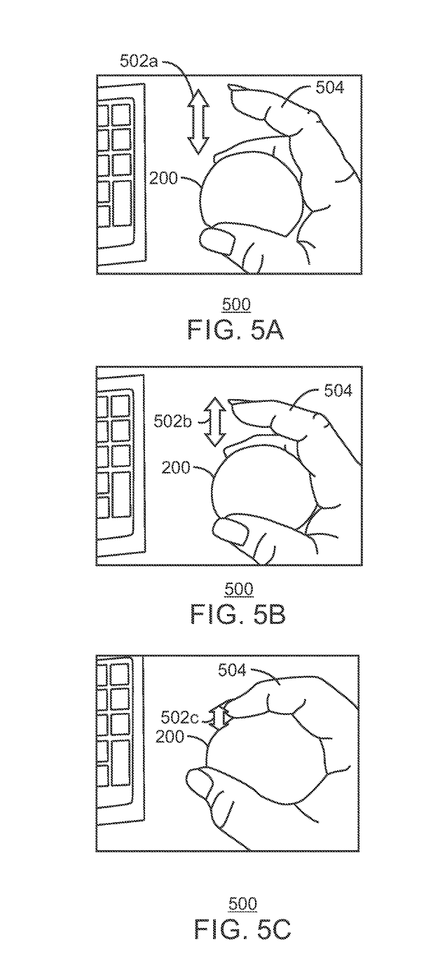

FIGS. 5A-5C are examples of hand movements corresponding with a point mouse action. Like numbers are as described with respect to FIG. 2. As shown in FIGS. 5A-5C, the user may perform a hand movement that includes tapping on a mouse 200 with a finger 504 to point to and then select an item on a display screen. FIG. 5A illustrates the finger 504 in an initial upward position 502a, as shown by a single bidirectional arrow, and in anticipation of moving in a downward direction. FIG. 5B illustrates the finger 504 in an intermediate position 502b as the finger continues to move in the downward direction. FIG. 5C illustrates the finger 504 in a position of direct contact 502c with an external surface of the mouse 200. To complete the tapping action on the mouse 200, the user lifts the finger 504 from the external surface of the mouse 200, as illustrated by the intermediate position 502b. The finger 504 continues in an upward motion until it returns to the initial upward position 502a. As illustrated, the progression of the finger positions 502a-c indicates a single tap on the mouse 200 using the finger 504.

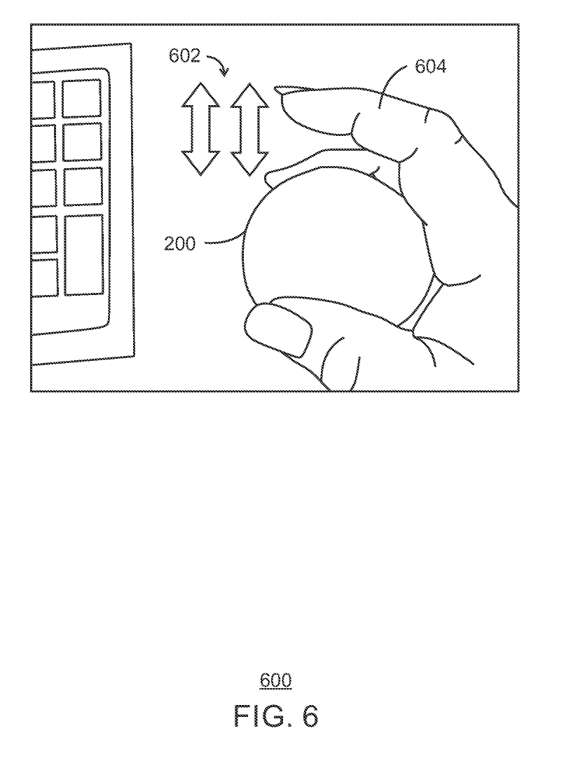

FIG. 6 is an example of a hand movement corresponding with a select mouse action. As shown, the user may perform a hand movement that includes tapping on the mouse 200 twice with a finger 604 in rapid succession, as illustrated by two bidirectional arrows 602. The select mouse action may allow a user to access an item or to open or close a window, as displayed on the screen, without accessing a display menu.

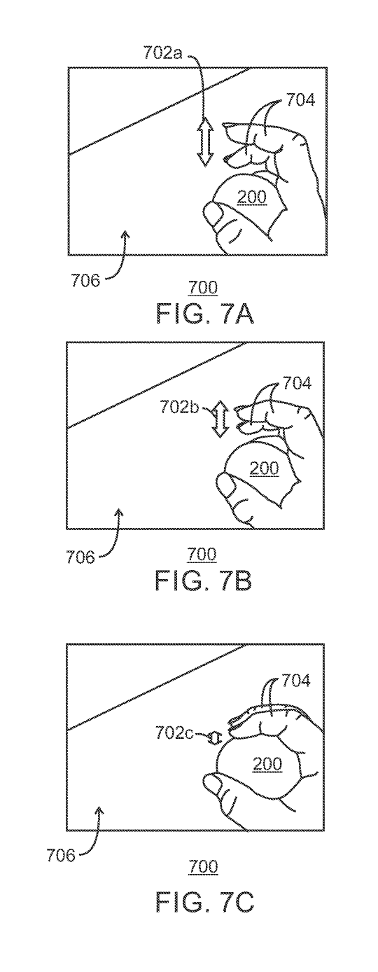

FIGS. 7A-7C are examples of hand movements corresponding with a menu mouse action. The user may perform a hand movement that includes tapping on the mouse 200 with two fingers 704 while the mouse 200 simultaneously rests on a surface 706. FIG. 7A illustrates a position of the two fingers 704 in an initial upward position 702a, as shown by a single bidirectional arrow, and in anticipation of moving in a downward direction. FIG. 7B illustrates the two fingers 704 at an intermediate position 702b before direct contact with the mouse 200 occurs.

FIG. 7C illustrates the two fingers 704 in a position of direct contact 702c with an external surface of the mouse 200. To complete the tapping action on the mouse 200, the user lifts the two fingers 704 from the external surface of the mouse 200, as illustrated by the intermediate position 702b. The two fingers 704 continue in an upward motion until it returns to the initial upward position 702a. As illustrated, the progression of the single bidirectional arrow 702a-c indicates a single tap on the mouse 200 using the two fingers 704 while the mouse 200 rests on the surface 706. By enacting the various positions 702a-c, a user may carry out the menu mouse action to access a drop down menu, as displayed on a screen, and make a selection from the menu.

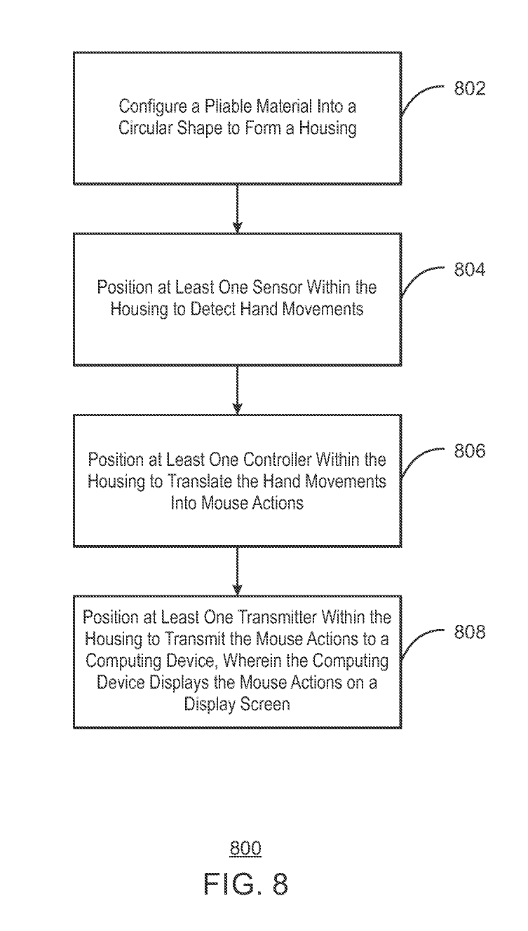

FIG. 8 is a process flow diagram for manufacturing a circular hand-held mouse. At block 802, a pliable material may be configured, or molded, into a circular shape to form a mouse housing where electronic components are embedded within the material. The pliable material may constitute the entire housing. In other examples, the mouse housing may include an internal frame structure where the structure may be embedded in the pliable material. Additionally, the pliable material may cover an outer surface of the internal frame structure to provide an external covering. A user may carry out various hand movements on the stress mouse by manipulating the mouse with hands, fingers, or both.

At block 804, at least one sensor may be positioned within the mouse housing to detect the hand movements that may act upon the mouse. For example, a number of pressure sensors may be located in various areas of the mouse to sense pressure from a human hand or fingers. In particular, the pressure sensors may be embedded in the pliable material. At block 806, at least one controller may be positioned within the mouse housing to interpret and translate the hand movement into a corresponding mouse action. The at least one controller may be embedded in the pliable material. As an example of a hand movement, a user may tap on the mouse followed by rolling the mouse. The controller can translate the hand movement to determine the mouse action that corresponds with the movement. Following the previous example, the hand movement may include the move mouse action. In some examples, additional hand movements made be added or the existing hand movements reconfigured to provide other types of mouse actions.

A processor may execute the mouse action and transmit information about the mouse action to a transmitter. At block 808, a transmitter may be positioned within the mouse housing to transmit the mouse actions to a computing device with a display screen. Based on the information received by the computing device, the display screen may display a pointer that imitates the mouse actions.

FIG. 900 is a block diagram showing a tangible, non-transitory computer-readable media 902 that stores code for the circular, hand-held stress mouse. A processor 904 may access the computer-readable media 902 via a system bus 906. Furthermore, the computer-readable media 902 may include code configured to direct the processor 904 to perform the methods described herein with respect to FIG. 8.

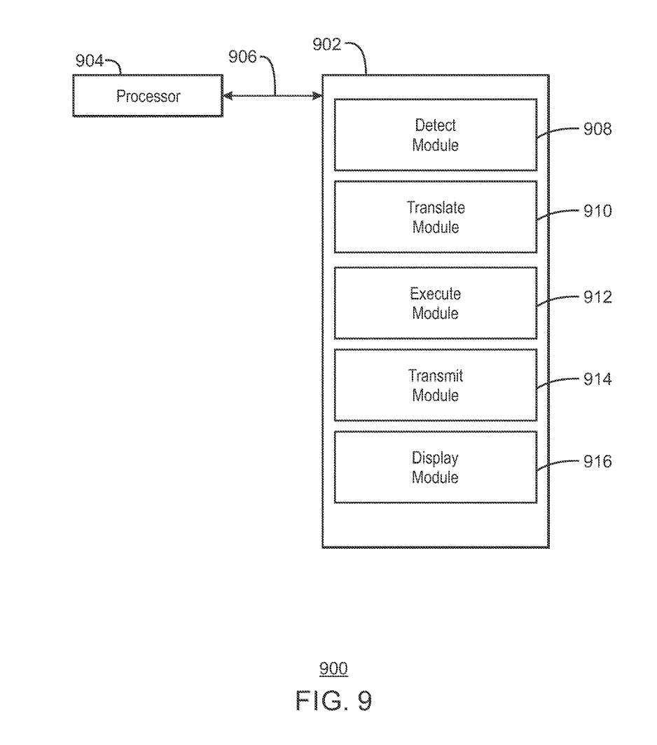

Various software components may be stored on one or more computer-readable media 902, as shown in FIG. 9. For example, a detect module 908 may be configured to detect hand movements that act upon a pointing device, for example, a computing mouse. A translate module 910 may be configured to translate the hand movement into its corresponding mouse action. An execute module 912 may be configured to read and convert the mouse action into readable data that a computing device can understand. A transmit module 914 may be configured to transmit the readable data to the computing device. A display module 916 may display the mouse action by moving a pointer on a display screen based on the readable data.

Examples may include subject matter such as systems to use a computing mouse in numerous locations and with various hand movements that provide an interactive approach when operating the mouse. The hand movements may change frequently with minimal to no limitations on the user. The computing mouse may be disabled and further used as a stress ball to reduce or alleviate tension.

Example 1 is a computing mouse. The computing mouse includes one or more sensors configured to detect at least one hand movement acting upon the mouse. The computing mouse includes one or more controllers configured to translate the at least one hand movement into a mouse action. The computing mouse may include a transmitter to transmit the mouse action to a computing device. The computing mouse may further include a mouse housing comprising a soft, pliable material, where the sensors, the controllers, and the transmitter are embedded within the soft, pliable material. The computing mouse may include an external covering to cover the mouse housing, where the external covering comprises a soft, pliable material.

The at least one hand movement may include tapping, rolling, bouncing, swiping, or squeezing, in any combination, thereof. The at least one hand movement may include manipulation of the mouse with a human hand, human fingers, or both, in any combination, thereof.

The mouse action may include a point action, a move action, a select action, an access-menu action, or a zoom action. The sensors include pressure sensors and motion sensors configured to detect the at least one hand movement. The sensors include temperature sensors configured to distinguish between a human touch and an inanimate object. The sensors may include acceleration sensors and compass sensors configured to detect a position of the mouse.

The computing mouse may include a shape of the mouse that is configured to be spherical, oval, elliptical, or cylinder, and where the mouse is configured to roll on a surface. The computing mouse may be configured to roll on a hard surface, a soft surface, or both.

The computing mouse may be configured to be used as a stress-ball when detection of the at least one hand movement is disabled. The computing mouse may be configured to operate as a wireless computing mouse.

The computing mouse may include a mouse housing that includes an internal frame structure made of prism segments.

Example 2 is a system including a pointing device and a computing device. The pointing device may include one or more of sensors to detect at least one hand movement acting upon the pointing device. The pointing device may include one or more controllers configured to translate the at least one hand movement into a pointing device action. The pointing device may include a transmitter to transmit the pointing device action. The pointing device may include a housing comprising a soft, pliable material, where the sensors, the controllers, and the transmitter are embedded within the housing.

The computing device may be configured to receive the pointing device action via a wireless technology from the transmitter.

The system may include the wireless technology that may include Bluetooth technology or computer networking (Wi-Fi) technology.

The system may include the pointing device action displayed on a display screen that may correspond to the at least one hand movement acting upon the pointing device.

The system may include the pointing device that may be a computing mouse. The system may include the pointing device that may be a stress ball when the pointing device is electrically disabled.

Example 3 is a method for manufacturing a hand-held stress mouse. The method may include configuring a pliable material into a circular shape to form a housing. The method may include positioning at least one sensor within the housing to detect at least one hand movement. The method may include positioning at least one controller within the housing to translate the at least one hand movement into a mouse action. The method may further include positioning at least one transmitter within the housing to transmit the mouse action, via a wireless technology, to a computing device, where the computing device displays the mouse action on a display screen.

The method may include a tap on the mouse housing with a finger or a bounce of the mouse housing on a surface that may be configured to simulate a point-and-select mouse action.

The method may include a tap on the mouse housing with a finger followed by a roll of the mouse housing on a surface that may be configured to simulate a move mouse action.

The method may include a bounce of the mouse housing on a surface followed by a roll of the mouse housing on a surface that may be configured to simulate a move mouse action.

The method may include a double-tap on the mouse housing or a double-tap of the mouse housing on a surface that may be configured to simulate a select mouse action.

The method may include a tap on the mouse housing with multiple fingers that may be configured to simulate an access-menu mouse action, where the mouse housing simultaneously rests on a surface.

The method may include a tap on the mouse housing with multiple fingers that may be configured to simulate an access-menu mouse action, where the mouse housing is simultaneously hand-held.

The method may include a single-squeeze of the housing mouse, a swipe of a surface of the mouse housing with fingers together, or a press of the mouse housing that may be configured to simulate a zoom-out mouse action.

The method may include a double-squeeze of the mouse housing or a swipe of a surface of the mouse housing with fingers apart that may be configured to simulate a zoom-in mouse action.

The method may include a mouse housing that may be configured to operate in a plurality of locations and positions.

The method may include restricting the use of the mouse housing within a pre-determined distance away from the computing device.

Example 4 is a tangible, machine-readable medium that may include code that, when executed causes a processor to detect a hand movement on a pointing device, translate the hand movement into a corresponding mouse action, execute the mouse action, transmit the mouse action to a computing device, and display the mouse action on a display screen of the computing device.

The tangible, machine-readable medium that may include disabling detection of the hand movement, where the disabling may configure the pointing device to be used as a stress ball.

The tangible, machine-readable medium where the pointing device may be configured to be a circular, hand-held computing mouse.

In the foregoing description and claims, the terms “coupled” and “connected,” along with their derivatives, can be used. It should be understood that these terms are not intended as synonyms for each other. Rather, in particular examples, “connected” can be used to indicate that two or more elements are in direct physical or electrical contact with each other. “Coupled” can mean that two or more elements are in direct physical or electrical contact. However, “coupled” can also mean that two or more elements are not in direct contact with each other, but yet still co-operate or interact with each other.

Some examples can be implemented in one or a combination of hardware, firmware, and software. Some examples can also be implemented as instructions stored on a machine-readable medium, which can be read and executed by a computing platform to perform the operations described herein. A machine-readable medium can include any mechanism for storing or transmitting information in a form readable by a machine, e.g., a computer. For example, a machine-readable medium can include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

Not all components, features, structures, characteristics, etc. described and illustrated herein need be included in a particular example or examples. If the specification states a component, feature, structure, or characteristic “can”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some examples have been described in reference to particular implementations, other implementations are possible according to some examples. Additionally, the arrangement and/or order of circuit elements or other features illustrated in the drawings and/or described herein need not be arranged in the particular way illustrated and described. Many other arrangements are possible according to some examples.

In each system shown in a figure, the elements in some cases can each have a same reference number or a different reference number to suggest that the elements represented could be different and/or similar. However, an element can be flexible enough to have different implementations and work with some or all of the systems shown or described herein. The various elements shown in the figures can be the same or different. Which one is referred to as a first element and which is called a second element is arbitrary.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter can be practiced without the specific details. In other instances, well-known features, components, or modules were omitted, simplified, combined, or split in order not to obscure the disclosed subject matter.

While the disclosed subject matter has been described with reference to illustrative examples, this description is not intended to be construed in a limiting sense. Various modifications of the illustrative examples, as well as other examples of the subject matter, which are apparent to persons skilled in the art to which the disclosed subject matter pertains are deemed to lie within the scope of the disclosed subject matter.

While the present techniques can be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

1. A computing mouse comprising:
one or more sensors to detect at least one hand movement acting upon the mouse;
one or more controllers to translate the at least one hand movement into a mouse action;
a transmitter to transmit the mouse action to a computing device; and
a mouse housing comprising a soft, pliable material, wherein the one or more sensors, the one or more controllers, and the transmitter are embedded within an internal frame structure within the soft, pliable material.

2. The computing mouse of claim 1, wherein the at least one hand movement comprises manipulation of the mouse with a human hand, human fingers, or both, in any combination, thereof.

3. The computing mouse of claim 1, wherein the one or more sensors comprise pressure sensors and motion sensors to detect the at least one hand movement.

4. The computing mouse of claim 1, wherein the one or more sensors comprise temperature sensors configured to distinguish between a touch initiated by a human and an inanimate object.

5. The computing mouse of claim 1, wherein the one or more sensors comprise acceleration sensors and compass sensors configured to detect a position of the mouse.

6. The computing mouse of claim 1, wherein the mouse is to be used as a stress-ball when detection of the at least one hand movement is disabled.

7. The computing mouse of claim 1, wherein a shape of the mouse is to be spherical, oval, elliptical, or cylinder, and wherein the mouse is to roll on a surface.

8. The computing mouse of claim 1, wherein the mouse is to operate as a wireless computing mouse.

9. A system, comprising:
a pointing device comprising,
one or more sensors to detect at least one hand movement acting upon the pointing device;
one or more controllers to translate the at least one hand movement into a pointing device action;
a transmitter to transmit the pointing device action; and
a housing comprising a soft, pliable material, wherein the one or more sensors, the one or more controllers, and the transmitter are embedded within an internal frame structure within the housing, wherein the internal frame structure is configured in a cylinder shape; and
a computing device configured to receive the pointing device action via a wireless technology from the transmitter.

10. The system of claim 9, wherein the wireless technology comprises Bluetooth technology or computer networking (Wi-Fi) technology.

11. The system of claim 9, wherein the pointing device action is to correspond to the at least one hand movement acting upon the pointing device.

12. The system of claim 9, wherein the pointing device is a computing mouse.

13. The system of claim 9, wherein the pointing device is a stress ball when the pointing device is electrically disabled.

14. A method for manufacturing a hand-held stress mouse, comprising:
configuring a pliable material into a circular shape surrounding an internal frame structure that is a single unitary member to form a housing;
positioning at least one sensor within the internal frame structure of the housing to detect at least one hand movement;
positioning at least one controller within the internal frame structure of the housing to translate the at least one hand movement into a mouse action; and
positioning at least one transmitter within the internal frame structure of the housing to transmit the mouse action, via a wireless technology, to a computing device, wherein the computing device displays the mouse action on a display screen.

15. The method of claim 14, wherein a tap on the housing with a finger or a bounce of the housing on a surface is configured to simulate a point-and-select mouse action.

16. The method of claim 14, wherein a tap on the housing with a finger followed by a roll of the housing on a surface is configured to simulate a move mouse action.

17. The method of claim 14, wherein a bounce of the housing on a surface followed by a roll of the housing on a surface is configured to simulate a move mouse action.

18. The method of claim 14, wherein a double-tap on the housing or a double-tap of the housing on a surface is configured to simulate a select mouse action.

19. The method of claim 14, wherein a tap on the housing with multiple fingers is configured to simulate an access-menu mouse action, wherein the housing simultaneously rests on a surface.

20. The method of claim 14, wherein a tap on the housing with multiple fingers is configured to simulate an access-menu mouse action, wherein the housing is simultaneously hand-held.

21. The method of claim 14, wherein a single-squeeze of the housing mouse, a swipe of a surface of the housing with fingers together, or a press of the housing is configured to simulate a zoom-out mouse action.

22. The method of claim 14, wherein a double-squeeze of the housing or a swipe of a surface of the housing with fingers apart is configured to simulate a zoom-in mouse action.

23. A tangible, machine-readable medium comprising code that, when executed causes a processor to:
detect a hand movement on a pointing device, wherein the pointing device is a pliable material configured into a circular shape surrounding an internal frame structure configured as a single unitary member;
translate the hand movement into a corresponding mouse action;
execute the mouse action;
transmit the mouse action to a computing device; and
display the mouse action on a display screen of the computing device.

24. The tangible, machine-readable medium of claim 23, comprising disabling detection of the hand movement, wherein the disabling configures the pointing device to be used as a stress ball.

25. The tangible, machine-readable medium of claim 23, wherein the pointing device is configured to be a circular, hand-held computing mouse.
